(19) United States
(12) Patent Application Publication
(10) Pub. No.: US 2003/0216921 A1
(43) Pub. Date: Nov. 20, 2003

(54) Method and system for limited domain text to speech (TTS) processing

(76) Inventors: Jianghua Bao, Bei Jing (CN); Joe F. Zhou, Bei Jing (CN)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/150,208

(22) Filed: May 16, 2002

(51) Int. Cl. G10L 13/08

(52) U.S. Cl. 704/260

(57) ABSTRACT

Methods and apparatuses for processing speech data are described herein. In one aspect of the invention, an exemplary method includes providing sufficient limited domain related texts, performing text processing on the limited domain related texts, generating recording scripts corresponding to the limited domain related texts, recording the recording scripts into a first speech file, performing speech processing on the first speech file, generating second speech files based on the first speech file, and creating a database for storing the second speech files. Other methods and apparatuses are also described.

### FIELD OF THE INVENTION

The invention relates to speech recognition. More particularly, the invention relates to limited domain text to speech (TTS) toolkit scheme in a speech recognition system.

### BACKGROUND OF THE INVENTION

Speech generation is the process which allows the transformation of a string of phonetic and prosodic symbols into a synthetic speech signal. Text to speech systems create synthetic speech directly from text input. Generally, two criteria are requested from text to speech (TTS) systems. The first is intelligibility and the second, pleasantness or naturalness. Text to speech systems (TTS) create artificial speech sounds directly from inputted text. Conventional TTS systems generally operate in a strictly sequential manner. The input text is divided by some external processes into relatively large segments such as sentences. Each segment is then processed in a predominantly sequential manner, step by step, until the required acoustic output can be created.

Current TTS systems are capable of producing voice qualities and speaking styles which are easily recognized as synthetic, but intelligible and suitable for a wide range of tasks such as information reporting, workstation interaction, and aids for disabled persons. However, more widespread adoption has been prevented by the perceived robotic quality of some voices, errors of transcription due to inaccurate rules and poor intelligibility of intonation-related cues. In general the problems arise from inaccurate or inappropriate modeling of the particular speech function in question. To overcome such deficiencies therefore, considerable attention has been paid to improving the modeling of grammatical information and so on, although this work has yet to be successfully integrated into commercially available systems.

A conventional text to speech system has two main components, a linguistic processor and an acoustic processor. The input into the system is text, the output is an acoustic waveform which is recognizable to a human as speech corresponding to the input text. The data passed across the interface from the linguistic processor to the acoustic processor comprises a listing of speech segments together with control information (e.g., phonemes, plus duration and pitch values). The acoustic processor is then responsible for producing the sounds corresponding to the specified segments, plus handling the boundaries between them correctly to produce natural sounding speech. To a large extent the operation of the linguistic processor and of the acoustic processor are independent of each other.

However, most of the conventional TTS systems are designed for general domain which are more complex systems. The conventional TTS system normally require the users equipped with certain degrees of TTS knowledge. In addition, since the conventional TTS deals with the general domain texts, it generally lacks of accuracy for limited domain texts. Furthermore, the users have to have special TTS knowledge to able to handle their limited domain TTS operations. As a result, it apparent to a person with ordinary skill in the art that a better limited domain TTS solutions are needed, such that the users are not required to have special TTS knowledge to build their limited domain TTS application.

### BRIEF DESCRIPTION OF THE DRAWINGS

The present invention is illustrated by way of example and not limitation in the figures of the accompanying drawings in which like references indicate similar elements.

FIG. 1 shows a block diagram of a limited domain TTS system according to one embodiment.

FIG. 2 shows a typical computer system which may be used with an embodiment.

FIG. 3 shows a block diagram of an embodiment for making a limited domain TTS database.

FIG. 4 shows an embodiment of a method for making a limited TTS application.

FIGS. 5 and 6 show an alternative embodiment of a method for making a limited TTS application.

### DETAILED DESCRIPTION

The following description and drawings are illustrative of the invention and are not to be construed as limiting the invention. Numerous specific details are described to provide a thorough understanding of the present invention. However, in certain instances, well-known or conventional details are not described in order to not unnecessarily obscure the present invention in detail.

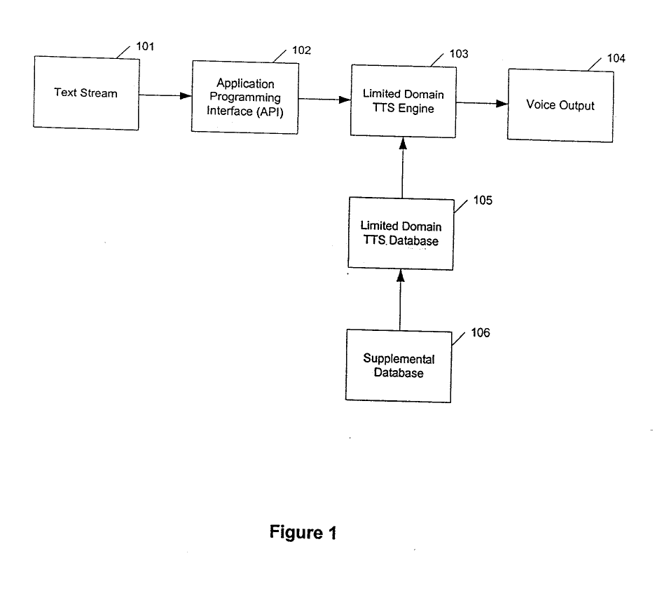

The present invention introduces a unique package to provide a user to easily build a limited domain TTS application. The invention is based on the idea that each user has its own limited domain that needs to be customized. The invention provides a solution that the user does not need to know the technicalities of the TTS technology. Instead, the user can easily use the invention to create their own database (e.g., libraries) to customize to his/her needs. FIG. 1 shows a block diagram of an embodiment of the present invention. Prior to processing the inputted text stream 101, the user constructs the database 105 containing all of the popular words in speech files customized to his/her needs (e.g., in a limited domain). When the text stream 101 is inputted to the TTS engine 103, through an application programming interface (API) 102, the TTS engine 103 utilizes the database 105 to match any speech files that represent the inputted text stream and generates the voice output 104. In addition, the invention provides a method to generate a supplemental database 106 to compensate the shortage of the main database 105. Thus if the speech files in the database 105 cannot represent the inputted text, the supplement database 106 will be used to generate the correct voice output. In one embodiment, the supplemental database is created by the user through the present invention. The user may record additional scripts and use the invention to perform speech processing on the customized recorded scripts to generate additional voice output to cover the area which the main database 105 does not cover. As a computer system is getting more popular and powerful, the TTS processing is more often implemented as a software package executed by a microprocessor of a computer system.

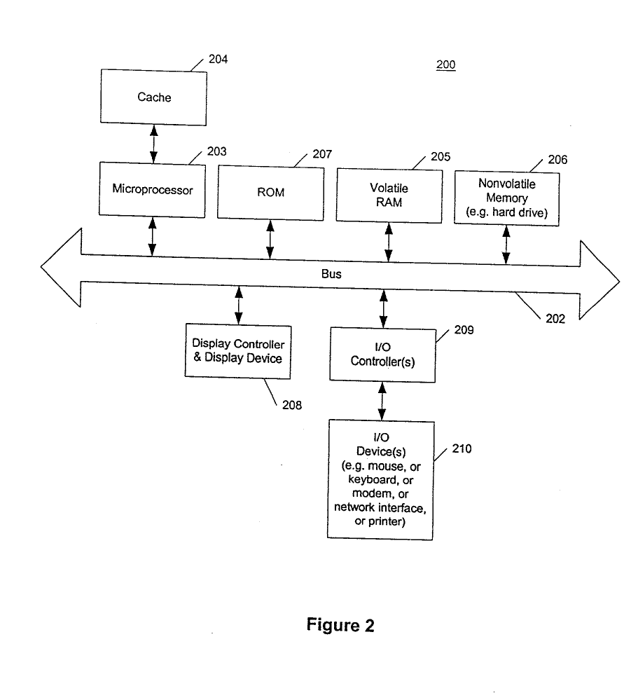

FIG. 2 shows one example of a typical computer system, which may be used with one embodiment of the present invention. Note that while FIG. 2 illustrates various components of a computer system, it is not intended to represent any particular architecture or manner of interconnecting the components, as such details are not germane to the present invention. It will also be appreciated that network computers and other data processing systems which have fewer components or perhaps more components may also be used with the present invention. The computer system of FIG. 2 may, for example, be an Apple Macintosh or an IBM compatible computer.

As shown in FIG. 2, the computer system 200, which is a form of a data processing system, includes a bus 202 which is coupled to a microprocessor 203 and a ROM 207 and volatile RAM 205 and a non-volatile memory 206. The microprocessor 203 is coupled to cache memory 204 as shown in the example of FIG. 2. The bus 202 interconnects these various components together and also interconnects these components 203, 207, 205, and 206 to a display controller and display device 208 and to peripheral devices such as input/output (I/O) devices, which may be mice, keyboards, modems, network interfaces, printers and other devices which are well known in the art. Typically, the input/output devices 210 are coupled to the system through input/output controllers 209. The volatile RAM 205 is typically implemented as dynamic RAM (DRAM) which requires power continuously in order to refresh or maintain the data in the memory. The non-volatile memory 206 is typically a magnetic hard drive, a magnetic optical drive, an optical drive, a DVD RAM, or other type of memory system which maintains data even after power is removed from the system. Typically, the non-volatile memory will also be a random access memory, although this is not required. While FIG. 2 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 202 may include one or more buses connected to each other through various bridges, controllers, and/or adapters, as is well-known in the art. In one embodiment, the I/O controller 209 includes a USB (Universal Serial Bus) adapter for controlling USB peripherals.

The present invention is provided as a toolkit that is used to facilitate users to develop their own limited domain text to speech (TTS) application with the least effort. Typically, there are a total of five modules, including: text processing, speech processing, database making module, limited domain TTS engine and a database supplement. Among them, the text processing and speech processing comprise a number of components that work together to achieve the goal of the TTS processing. For example, in text processing, the processes normally contain text normalization, n-gram frequency calculation etc. In speech processing, the processes normally contain sentence analysis, forced alignment, etc. The whole procedure of building a specific application can sequentially go through three stages, text processing, speech processing, database making.

Prior to the processes, a user has to collect sufficient domain related texts. The text processing module processes the domain related texts, and generates recording script. During the text processing, the system normalizes the texts such as numbers and expands the symbols. In some cases the system has to do word segmentation as needed. Then the system produces a list of every word that occurred in the text, along with its number of occurrences. The system also produces a list of every word n-gram that occurred in the text, along with its number of occurrences. Next, the top n-gram words are selected and are used to generate a candidate list. Recording scripts are generated from the candidate list.

With the recording scripts, the user needs to record the scripts transmits the recorded scripts to the speech processing module. The recording scripts are normally recorded into a speech file. During the speech processing, the speech processing module cuts the speech file into a series of little wave files named “n.wav”. Each wave file may contain a sentence. Next, the silence at the head and end of each wave file may be removed. Then the sampling rate of the wave file may be adjusted. In one embodiment, the invention provides the user an opportunity to examine the recording scripts whether there is any error occurred during the processing. The system then may label the speech to mark phoneme boundary.

Once the user completed the speech processing, the user may create the database and index using the database making module. The database contains most of the words which are frequently used. The database may be a single database, or it may be multiple databases. The TTS engine is always available. The user can access the TTS engine at any time to generate voice output. If the user doesn't know how to program with the engine API, a little application with a simple interface is provided with the package to convert the text to speech.

The conventional approach is to use general domain TTS to accomplish the TTS operation. The user has to know the TTS technology in general and the programming is burdensome. In addition, the general purpose TTS would not focus on the area that the user is interested in, and it normally would not generate accurate and satisfied results. As a result, a user has to spend dramatic amount of time on the application. The invention provides complete toolkit to deal with all the steps involved in making a limited domain TTS application that requires no special TTS knowledge requirements to the user.

The invention covers all the components that are possibly useful in building a limited domain TTS application. All the modules are systematically and functionally clearly defined. Every module is something like a black box. Users only need to attend to the input and output. The ultimate goal of text processing module is to produce a recording script consisting of a number of logically non-connected sentences. Speech processing module is used to extract each sentence from the huge recorded speech file and to produce a series of small speech files corresponding to each sentence in the recording script. Some products of text processing and speech processing are used as input of database making module to make database. Also, the input and output of every component in each module are clearly defined. Although the components are functionally independent, they are actually tightly correlated in terms of the working flow. However users do not need to know about the specific format of the input and the output. The whole procedure is pipelined, and the user is only required to know what tool should be used at each step.

In order to support different domains, the text-processing module is actually domain independent, and so is the limited domain TTS engine. There are several API provided for the user to use this engine. After creating the database, the users can directly call the engine to generate voice output, so users do not need to worry about their lack of knowledge of the speech synthesis. Another assurance for handling various domains is the additional recording script that can be recorded and processed by speech processing module and database making module to make a database as a supplement. This recording script is elaborated so that it can compensate the shortage of the created recording script. However users do not need to pay attention to how to retrieve data, from the supplemental database since the database is already bound with the engine. The users have an option to build an additional database.

According to one embodiment of the invention, it is easy for users to build their own specific domain TTS. What users need to do is to collect sufficient domain related text in advance and record the script produced by the text processing modules. This toolkit provides a complete solution for limited domain TTS applications. People that may use this toolkit or part of it can be various, since this toolkit aims at those who have no special technology about TTS. An ordinary people can easily build their own customized TTS application for their own purposes.

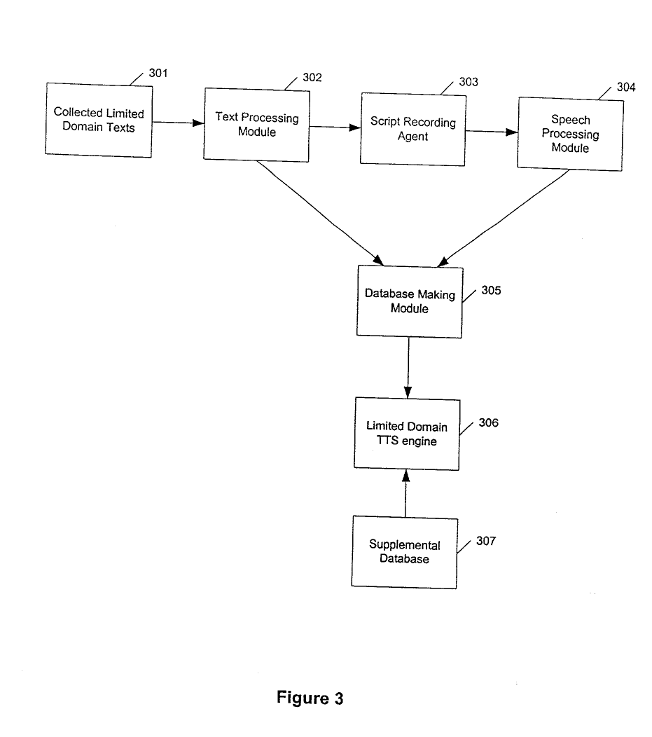

FIG. 3 shows a block diagram for generating a limited domain database used in one embodiment of the present invention. Referring to FIG. 3, users collect in advance sufficient limited domain related texts 301. The texts 301 then are transmitted to the text processing module 302 for text processing. The text processing may include text normalization and n-gram frequency calculations, etc. As a result, a set of recording scripts is generated through the text processing module. Next the recording scripts are recorded through a recording device 303, such as microphone, into a speech file (e.g., a wave file). The speech file is then inputted into the speech processing module 304 for speech processing. During the speech processing, the system may divide the speech file into multiple small speech files, wherein each of the small speech files may contain a sentence. The speech processing module may also remove the silence, adjust the sampling rate, etc. As a result, a plurality of speech files is generated. Then the database making module 305 builds a database based on the information provided by the speech files generated from the speech processing module. In one embodiment, the database making module may utilize the information generated from both text processing module and the speech processing module. The database generated by the database making module is then used by the TTS engine 306 to convert the text to speech. In one embodiment, the system also provides a supplemental database 307 to assist the database 305 to compensate any word that is not supported by the database 305. In one embodiment, the supplemental database is generated by the users through recording additional scripts and processing the scripts using speech processing module 304. As a result, the users can easily build their own TTS applications without knowing detailed information regarding to the TTS technology.

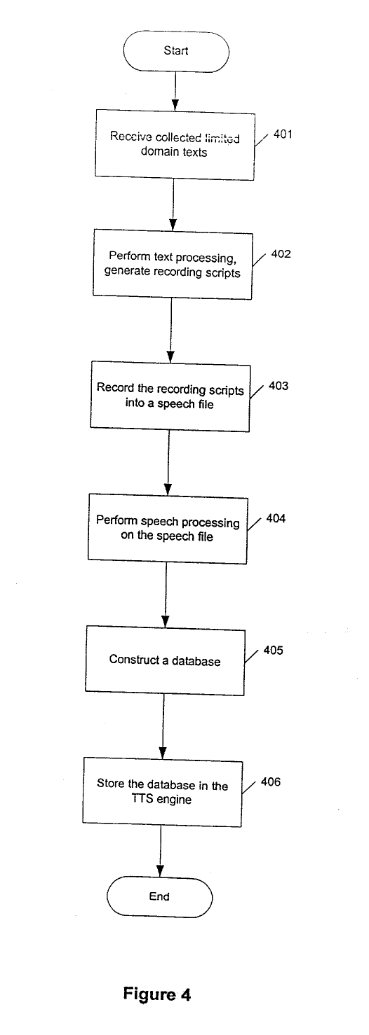

FIG. 4 shows a method for creating a limited domain TTS database used in an aspect of the present invention. The method involves providing sufficient limited domain related texts, performing text processing on the limited domain related texts, generating recording scripts corresponding to the limited domain related texts, recording the recording scripts into a first speech file, performing speech processing on the first speech file, generating second speech files based on the first speech files, and creating a database for storing the second speech files.

Referring FIG. 4, the system receives 401 the domain related texts collected by the users. The system then performs 402 text processing on the texts and generates a plurality of recording scripts based on the text processing. The users then record 403 the recording scripts generated by the text processing module and generate a speech file through a recording device. In another embodiment, the recording scripts may be recorded automatically by a recording device through an interface. Next the speech processing module performs 404 speech processing on the speech file, including dividing the speech file into multiple small speech file, removing silence, and adjusting the sampling rate, etc. Then the database making module constructs 405 a database based on the speech files generated by the speech processing module and stores 406 the database in the TTS engine for TTS operation.

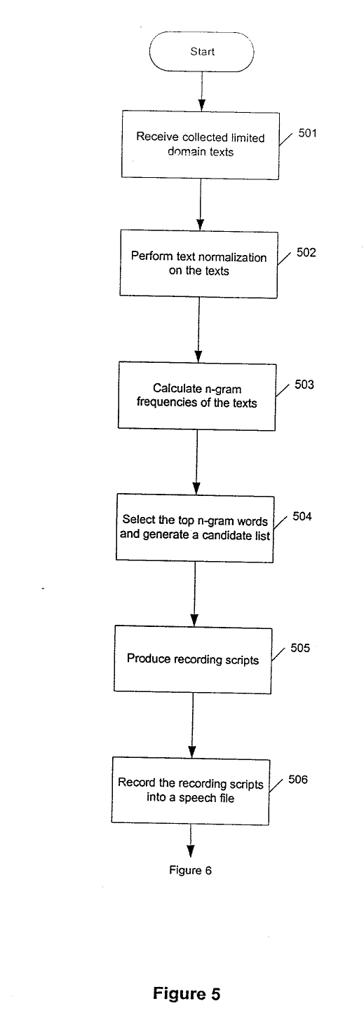

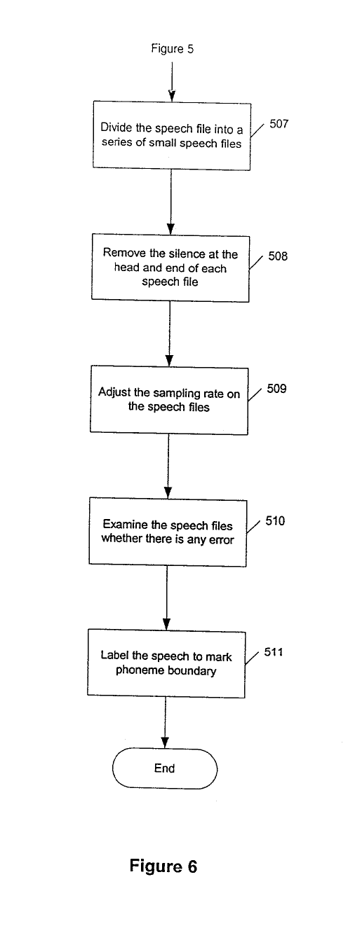

FIGS. 5 and 6 show an alternative embodiment of a method of an aspect of the invention. Here the text processing module receives 501 the domain related texts from the user and performs text processing on the inputted texts. Next the method involves performing 502 text normalization, calculating 503 n-gram frequencies, selecting 504 the top n-gram words to generate a candidate list, and producing 505 recording scripts for the users. The users then can record 506 those recording scripts into a speech file (e.g., a wave file). The speech processing module then performs the speech processing on the speech file, by dividing 507 the speech file into a plurality of the small speech files, removing 508 the silence from the speech files, adjusting 509 the sampling rate according to the users' requirement. The system also provides the users opportunities to examine 510 whether the processing is satisfied. Once the processing is satisfied, the speech processing module labels 511 the speech to mark phoneme boundary.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method, comprising:
providing sufficient limited domain related texts;
performing text processing on the limited domain related texts, generating recording scripts corresponding to the limited domain related texts;
recording the recording scripts into a first speech file;
performing speech processing on the first speech file, generating second speech files based on the first speech file; and
creating a first database for storing the second speech files.

2. The method of claim 1, further comprising:
receiving a text stream from an application programming interface (API);
performing analysis on the text stream, generating a plurality of sub-texts;
retrieving third speech files corresponding to the sub-texts from the first database; and
generating a voice output based on the third speech files corresponding to the sub-texts.

3. The method of claim 1, wherein performing text processing comprises:
performing text normalization on the limited domain related texts;
calculating n-gram frequencies for each limited domain related text;
generating a list of each word with n-gram that occurred in the text and number of occurrences;
generating candidate list based on the list of every word with n-gram; and
creating recording scripts for the limited domain related texts.

4. The method of claim 3, further comprising generating a list of each word that occurred in the text and number of occurrences.

5. The method of claim 3, further comprising selecting candidates with top n-gram frequencies from the candidate list.

6. The method of claim 1, wherein performing speech processing comprising:
dividing the first speech file into the second speech files;
removing silence from the second speech files;
adjusting sampling rate on the second speech files; and
performing alignments the second speech files.

7. The method of claim 6, further comprising extracting sentences from the first speech file and converting extracted sentences into the second speech files.

8. The method of claim 1, further comprising:
generating second recording scripts;
recording the second recording scripts;
performing speech processing on the second recording scripts, generating fourth speech files; and
creating a second database based on the fourth speech files.

9. The method of claim 8, further comprising examining the second speech files to determine whether there is any error.

10. The method of claim 9, further comprising correcting the error through the second database, if there is an error in the second speech files.

11. The method of claim 1, wherein each of the first recording scripts comprises a sentence.

12. The method of claim 8, wherein the second database is a supplemental database to the first database.

13. A system comprising:
a text processing module to process limited domain related texts, generating recording scripts;
a speech processing module to perform speech processing on the recording scripts, generating first speech files;
a database making module to create a database based on the first speech files;
a storage location to store the database; and
a TTS engine to perform TTS operation on inputted text stream, generating a voice output through the database.

14. The system of claim 13, further comprising a recording agent to record the recording scripts into a second speech file, the speech processing module processing the second speech file into the first speech file.

15. The system of claim 13, further comprising an application programming interface (API) for receiving the limited domain related texts.

16. The system of claim 15, wherein the API receives a text stream and transmits to the TTS engine for TTS processing.

17. The system of claim 13, further comprising a supplemental database coupled to compensate the shortage of the created recording scripts.

18. The system of claim 17, wherein additional scripts can be recorded and processed by the speech processing module and the database making module to create the supplemental database.

19. The system of claim 13, further comprising a user interface for a user to examine the first speech files whether there is an error in the first speech files.

20. The system of claim 19, wherein if there is an error in the first speech files, the user interface allows the user to correct the error, through a supplemental database.

21. A machine-readable medium having stored thereon executable code which causes a machine to perform a method, the method comprising:
providing sufficient limited domain related texts;
performing text processing on the limited domain related texts, generating recording scripts corresponding to the limited domain related texts;
recording the recording scripts into a first speech file;
performing speech processing on the first speech file, generating second speech files based on the first speech file; and
creating a first database for storing the second speech files.

22. The machine-readable medium of claim 21, wherein the method further comprises:
receiving a text stream from an application programming interface (API);
performing analysis on the text stream, generating a plurality of sub-texts;
retrieving third speech files corresponding to the sub-texts from the first database; and
generating a voice output based on the third speech files corresponding to the sub-texts.

23. The machine-readable medium of claim 21, wherein performing text processing comprises:
performing text normalization on the limited domain related texts;
calculating n-gram frequencies for each limited domain related text;
generating a list of each word with n-gram that occurred in the text and number of occurrences;
generating candidate list based on the list of every word with n-gram; and
creating recording scripts for the limited domain related texts.

24. The machine-readable medium of claim 23, wherein the method further comprises generating a list of each word that occurred in the text and number of occurrences.

25. The machine-readable medium of claim 23, wherein the method further comprises selecting candidates with top n-gram frequencies from the candidate list.

26. The machine-readable medium of claim 21, wherein performing speech processing comprising:
dividing the first speech file into the second speech files;
removing silence from the second speech files;
adjusting sampling rate on the second speech files; and
performing alignments the second speech files.

27. The machine-readable medium of claim 26, wherein the method further comprises extracting sentences from the first speech file and converting extracted sentences into the second speech files.

28. The machine-readable medium of claim 21, wherein the method further comprises:
generating second recording scripts;
recording the second recording scripts;
performing speech processing on the second recording scripts, generating fourth speech files; and
creating a second database based on the fourth speech files.

29. The machine-readable medium of claim 28, wherein the method further comprises examining the second speech files to determine whether there is any error.

30. The machine-readable medium of claim 29, further comprising correcting the error through the second database, if there is an error in the second speech files.
